(19) United States
(12) Patent Application Publication
(10) Pub. No.: US 2023/0074113 A1
(43) Pub. Date: Mar. 9, 2023

(54) DIALOGUE USER EMOTION INFORMATION PROVIDING DEVICE

(71) Applicant: MARUCOM HOLDINGS INC., Chiba (JP)

(72) Inventor: Yukihiro MARU, Chiba (JP)

(21) Appl. No.: 17/794,153

(22) PCT Filed: Feb. 1, 2021
(86) PCT No.: PCT/JP2021/003558

§ 371 Date: Jul. 20, 2022

(30) Foreign Application Priority Data
Feb. 3, 2020 (JP) 2020-016175

(51) Int. Cl. H04N 7/14; G06V 40/16

(52) U.S. Cl. CPC H04N 7/147; G06V 40/174

(57) ABSTRACT

[Problem to be Solvent] To improve the communication of interactive users.

[Solution] A device that supports a video interaction between a first user and a second user using an input/output terminal of a first user and an input/output terminal of a second user who are located remotely apart from each other in one embodiment of the present invention, the device comprising: an input reception unit that receives viewpoint information of the first user on the interaction device of the first user, an analysis unit that analyzes the viewpoint information, and an emotion information generating unit that generates emotion information based on the analyzed viewpoint information.

### TECHNICAL FIELD

The present invention relates to a device for providing emotion information of a dialogue user in an interaction between users who are remotely apart from each other.

### BACKGROUND ART

In recent years, video and telephone conferences have become widespread, and techniques for achieving smooth communication in interaction with users who are remotely apart from each other have been provided.

For example, in Patent Literature 1, a technique for analyzing the gaze direction of a user from an image captured by an image pickup unit provided in the vicinity of a display unit of a video conference device, expanding a screen region of interest to the user, and distributing it to the user is disclosed.

### PRIOR ART LIST

### Patent Literature

[Patent Literature 1] Japanese Unexamined Patent Publication No. 2014-050018

### SUMMARY OF THE INVENTION

### Technical Problem

However, Patent Literature 1 does not disclose a technique for improving communication by transmitting the emotions of interactive users who are remotely apart.

Therefore, the object of the present invention is to improve the communication of interactive users who are remotely apart from each other.

### Technical Solution

According to one embodiment of the present invention, there is provided a device that supports a video interaction between a first user and a second user using an input/output terminal of a first user and an input/output terminal of a second user who is located remotely apart from each other, the device comprising: an input reception unit that receives viewpoint information of the first user on the interaction device of the first user, an analysis unit that analyzes the viewpoint information, and an emotion information generating unit that generates emotion information based on the analyzed viewpoint information.

### Advantageous Effects

According to the present invention, it is possible to improve the communication of interactive users who are located remotely apart from each other.

### BRIEF DESCRIPTION OF THE DRAWINGS

FIG. 1 is a block diagram showing a remote interaction system according to the first embodiment of the present invention.

FIG. 2 is a functional block diagram showing the server terminal 100 of FIG. 1.

FIG. 3 is a functional block diagram showing the interaction device 200 of FIG. 1.

FIG. 4 illustrates an image pickup unit as an example of an interaction device.

FIG. 5 shows an example of user data stored in the server 100.

FIG. 6 is a diagram showing an example of analysis data stored in the server 100.

FIG. 7 shows an example of emotion information stored in the server 100.

FIG. 8 is emotion information expressed in time series.

FIG. 9 shows another example of emotion information stored in the server 100.

FIG. 10 is a flowchart showing a method of generating emotion information according to the first embodiment of the present invention.

### DETAILED DESCRIPTION OF THE EMBODIMENTS

Hereinafter, embodiments of the present invention will be described regarding the accompanying drawings. Further, the embodiments described below do not unreasonably limit the content of the present invention described in the claims. Additionally, all components shown in the embodiments are not always essential components of the present invention.

<Configuration>

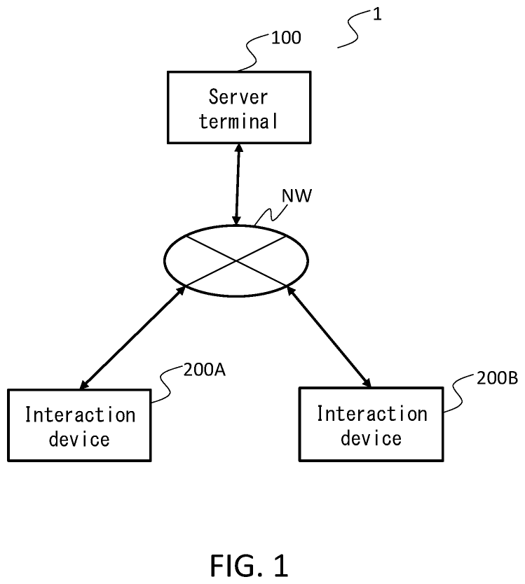

FIG. 1 is a block diagram showing a remote interaction system according to the first embodiment of the present invention. This system 1 includes a server terminal 100 that stores and analyses viewpoint information and generates emotion information, and interaction devices 200A and 200B that are used for interaction between users, have a built-in image pickup unit such as a camera and acquire viewpoint information of the user. Further, for convenience of explanation, a single server terminal and two interaction devices are described, but the system may be composed of a plurality of server terminals and one or two or more interaction devices.

The server terminal 100 and the interaction devices 200A and 200B are connected via the network NW. The network NW comprises the Internet, an intranet, a wireless LAN (Local Area Network), a WAN (Wide Area Network), and the like.

The server terminal 100 may be, for example, a general-purpose computer such as a workstation or a personal computer or may be logically realized by cloud computing.

The interaction device 200 may be configured by, for example, an information processing device such as a personal computer or a tablet terminal, a smartphone, a mobile phone, a PDA, or the like, in addition to a video conference device. Further, for example, as the interaction device, a personal computer, a smartphone, and a liquid crystal display device are connected by short-range wireless communication or the like. Then while displaying images of the own user and other users who perform interaction on the liquid crystal display device, it may be configured to enable necessary operations to be performed via a personal computer or a smartphone.

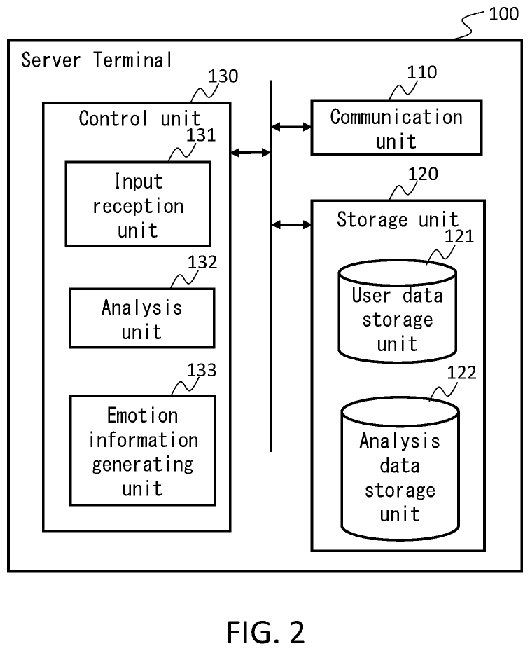

FIG. 2 is a functional block diagram showing the server terminal 100 of FIG. 1. The server terminal 100 includes a communication unit 110, a storage unit 120, and a control unit 130.

The communication unit 110 is a communication interface that communicates with the interaction device 200 via the network NW. For example, communication is performed according to a communication standard such as TCP/IP (Transmission Control Protocol/Internet Protocol).

The storage unit 120 stores various control processes, each function in the control unit 130, programs for executing remote interaction applications, input data, and the like, and comprises RAM (Random Access Memory), ROM (Read Only Memory), and the like. Further, the storage unit 120 has a user data storage unit 121 that stores various data related to the user, and an analysis data storage unit 122 that stores analysis data obtained by analyzing viewpoint information from the user and emotion information generated based on the analysis results. Further, a database (not shown) storing various data may be constructed outside the storage unit 120 or the server terminal 100.

The control unit 130 controls the overall operation of the server terminal 100 by executing the program stored in the storage unit 120 and comprises a CPU (Central Processing Unit), a GPU (Graphics Processing Unit), and the like. The function of the control unit 130 includes an input reception unit 131 that receives information such as viewpoint information from each device, an analysis unit 132 that analyzes viewpoint information, an emotion information generating unit 133 that generates emotion information based on the analysis result of viewpoint information. The input reception unit 131, the analysis unit 132, and the emotion information generating unit 133 are started by the program stored in the storage unit 120 and executed by the server terminal 100, which is a computer (electronic computer).

The input reception unit 131 can receive the viewpoint information of the user acquired by the interaction device 200. In the case of video interaction, it can receive voice information, image information, and the like from the user. The received viewpoint information of the user can be stored in the user data storage unit 121 and/or the analysis data storage unit 122 of the storage unit 120.

The analysis unit 132 analyses the received viewpoint information and can store the analyzed viewpoint information in the user data storage unit 121 and/or the analysis data storage unit 122.

The emotion information generating unit 133 can generate emotion information based on the analyzed viewpoint information. It can store the emotion information in the user data storage unit 121 and/or the analysis data storage unit 122.

Further, the control unit 130 may also have an emotion information notification control unit (not shown). For example, in order to notify the emotion information via the notification unit provided in the interaction device 200, when the notification unit is a vibration motor or the like that vibrates the smartphone terminal, the control unit can generate a control signal for activating vibration based on the emotion of the interactive user and can transmit the control signal to an interaction device different from the interactive user.

Further, the control unit 130 may have a screen generation unit (not shown), which generates screen information displayed via the user interface of the interaction device 200. For example, a user interface (for example, a dashboard for visualizing and showing advertising effectiveness to advertisers) is generated by using images and text data (not shown) stored in the storage unit 120 as materials and arranging various images and texts in a predetermined area of the user interface based on a predetermined layout rule. The processing related to the image generation unit can also be executed by the GPU (Graphics Processing Unit). In particular, when it is desired to visualize the generated emotion information and display it on the interaction device 200, the screen generation unit can generate screen information visualized by identifying the emotion information as a color, a character, or the like.

Further, the control unit 130 can execute various processes included in the remote interaction application for realizing a remote interaction by video between a plurality of users.

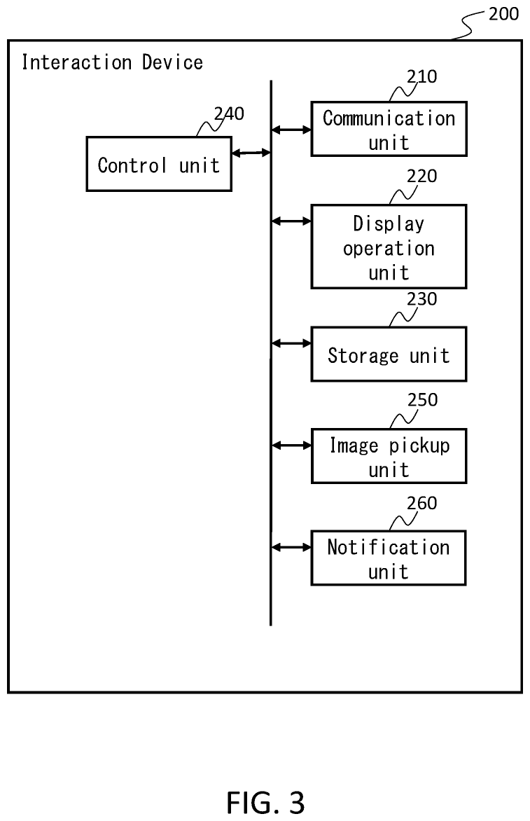

FIG. 3 is a functional block diagram showing the interaction device 200 of FIG. 1. The interaction device 200 includes a communication unit 210, a display operation unit 220, a storage unit 230, a control unit 240, an image pickup unit 250, and a notification unit 260.

The communication unit 210 is a communication interface for communicating with the server terminal 100 and another interaction device 200 via the network NW, and communication is performed based on a communication protocol such as TCP/IP.

The display operation unit 220 is a user interface used for the user to input an instruction and display text, an image, or the like according to the input data from the control unit 240. This comprises a display, keyboard and mouse when the interaction device 200 consists of a personal computer, and comprises a display, keyboard and mouse when the interaction device 200 consists of a smartphone or a tablet terminal. The display operation unit 220 is started by a control program stored in the storage unit 230 and executed by the interaction device 200 which is a computer (electronic computer).

The storage unit 230 stores programs, input data, and the like for executing various control processes and respective functions in the control unit 440, and is composed of a RAM, a ROM, and the like. Further, the storage unit 230 temporarily stores the communication content with the server terminal 100.

The control unit 240 controls the overall operation of the interaction device 200 by executing a program stored in the storage unit 230 (including a program included in the remote interaction application) and is composed of CPU, GPU, and the like.

When the interaction device 200 is composed of a personal computer, a smartphone, a tablet terminal, or the like, it can have an image pickup unit 250, such as a built-in camera capable of capturing the user's eyeball with infrared rays and tracking the user's viewpoint position on the liquid crystal display screen. When it is composed of a smartphone or the like, it can have a notification unit for notifying the user of emotional information, such as a vibration motor that generates vibration.

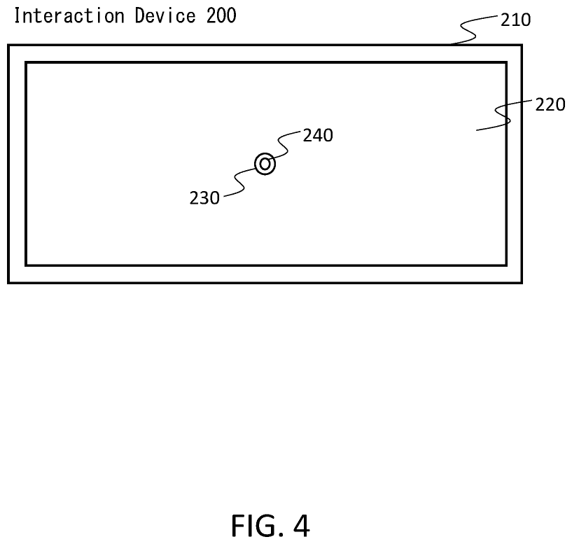

FIG. 4 illustrates an image pickup unit as another example of an interaction device.

The interaction device 200 shown in FIG. 4 includes a liquid crystal display device 210, and is provided with a through-hole 230 in the central part of the liquid crystal display unit 220 so that the CCD camera 240 is fitted into the through-hole 230. The interaction device 200 of the present embodiment further includes a smartphone (not shown) connected to the liquid crystal display device 210 through short-range wireless communication or wire, and the smartphone can execute various processes such as video calls and screen sharing included in remote interaction applications and can display a screen generated from image information transmitted via the server terminal 100 and the network NW on the liquid crystal display unit 210 of the liquid crystal display device 210, from the interaction device 200A of the user. The CCD camera 240 can capture the eyeball of the user using the interaction device 200 with infrared rays to track the viewpoint position of the user on the liquid crystal display device. By providing an image pickup unit (CCD camera) in the central part of the liquid crystal display unit, a user who performs an interaction using the liquid crystal display unit can interact with an interactive user of the other party displayed on the liquid crystal display unit in a natural form. In the present embodiment, in order to realize such a natural interaction method, it is preferable to display so that the position of the other user's face (more preferably the position of the eye) coincides with the region where the image pickup unit is located. When the other user moves, it is preferable that the camera provided in the interaction device of the other user is always followed so that the face is always located in the center.

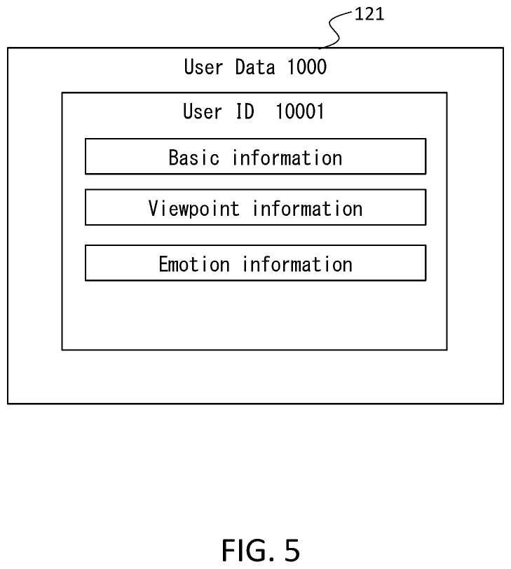

FIG. 5 is a diagram showing an example of user data stored in the server 100.

The user data 1000 stores various data related to the user. In FIG. 5, for convenience of explanation, an example of one user (scheduled to be identified by the user ID “10001”) is shown, but information related to a plurality of users can be stored. Various data related to the user may include, for example, basic user information (e.g., information used as attribute information as a user such as “name, address, age, gender, occupation”), viewpoint information (e.g., visual position information on the liquid crystal display screen of the user identified by the user ID “10001” analyzed based on the captured image), and emotional information (e.g., emotion information of the user identified by the user ID “10001” generated based on the viewpoint position information).

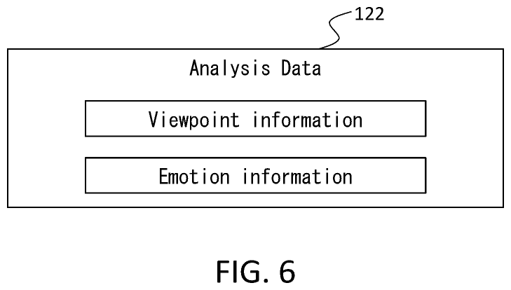

FIG. 6 shows an example of analysis data stored in the server 100.

The analysis data may include viewpoint information (e.g., viewpoint position information on the liquid crystal display screen of each user analyzed based on the captured image) and emotion information (e.g., emotion information of each user generated based on viewpoint position information).

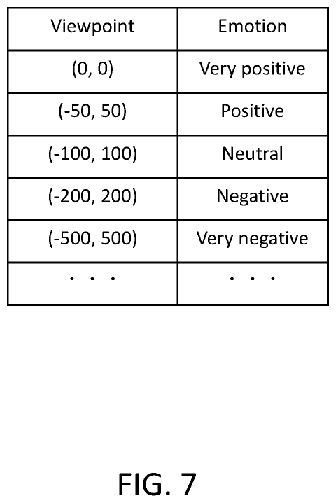

FIG. 7 shows an example of emotion information stored in the server 100.

In the emotion information table shown in FIG. 7, for example, when the user defines the coordinates of the central part of the liquid crystal display unit (liquid crystal display screen) as (0, 0) in the x-axis and y-axis directions, it is configured to track the viewpoint position of the user from the top of the table to the bottom and include the corresponding emotional information. For example, in a liquid crystal display screen where an image of an interactive user interacting with a certain user is displayed in the center of the screen, when the user sets the viewpoint to the viewpoint position (0, 0), that is, the center of the screen, it can be presumed that the user is very positive (highly interested) in communicating with the interactive user. On the other hand, as the user's viewpoint moves away from the center of the screen, it can be presumed that the user becomes negative (less interested) in the communication. Here, for the emotion information corresponding to the user's viewpoint position (coordinate), it is also possible to set the protocol in advance to correspond to the range of coordinates with the coordinates of the central part as the center, and it is also possible to output emotion information from input of viewpoint information by machine learning, by using the combination of past viewpoint information and emotion information of one user and/or the combination of past viewpoint information and emotion information of plural users as a learning model. When generating the learning model, feedback of emotion information from the user can also be obtained by additional information such as surveys and voice information. In the case of using voice information, for example, it is possible to detect the user's emotion from the voice information, perform natural language analysis from the voice information, detect the emotion information from the interaction content, and evaluate it as an output for the input information (viewpoint information).

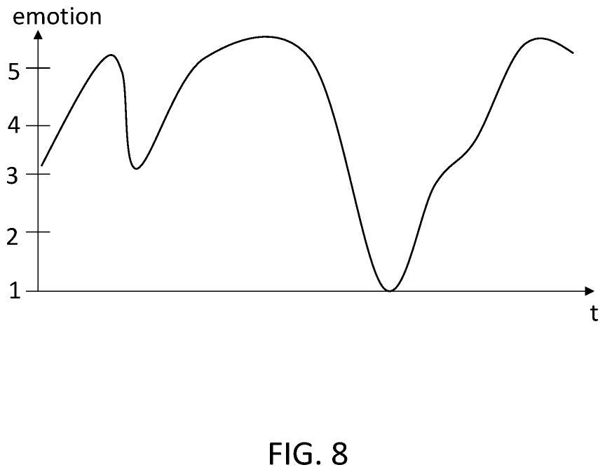

FIG. 8 shows emotion information expressed in time series.

In FIG. 8, the vertical axis shows the user's emotions in five stages (1: Very Negative, 2: Negative, 3: Neutral, 4: Positive, 5: Very Positive), and the horizontal axis is shown in a time axis. As shown in FIG. 8, emotion information is derived based on the user's viewpoint information, which can be expressed in time series. In FIG. 8, it is visualized that the user shows a high interest in communication at the beginning of the interaction, becomes less interested in the middle, and then gradually shows an increase in the interest. As described above, the transition of such visualized emotion information is generated as screen information by the screen generation unit of the server terminal 100, transmitted to the interaction device 200, and displayed, whereby the user can communicate while referring to the transition of the emotion information of the interactive user.

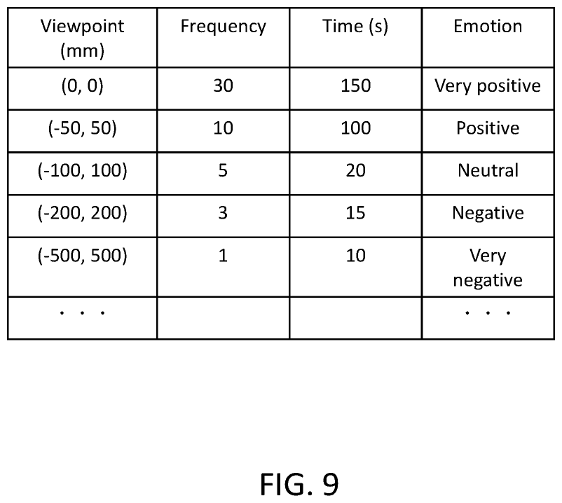

FIG. 9 shows another example of emotion information stored in the server 100.

As shown in FIG. 9, by counting the number of times of the viewpoint information of the user for each position and/or storing the cumulative total of the gaze time, it is possible to measure how the user feels as a whole communication with the interactive user (including the development progress). For example, from the information shown in FIG. 9, the user can understand throughout the communication that the viewpoint position is most focused on the coordinates (0, 0), that is, the center of the screen, and it can be seen that the user has a Very Positive feeling about communication.

### <Processing Flow>

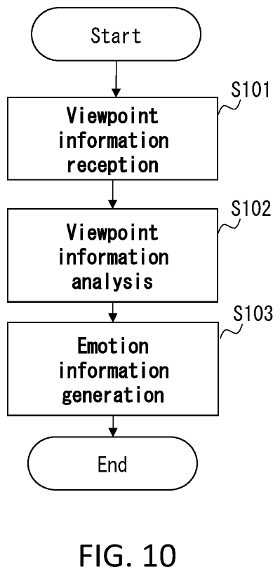

The flow of the emotion information generating processing executed by the system 1 of the present embodiment will be described with reference to FIG. 10. FIG. 10 is a flowchart showing a method of generating emotion information according to the first embodiment of the present invention.

Here, in order to use the present system 1, the user accesses the server terminal 100 by using the web browser, application or the like of each interaction device. When using the service for the first time, the above-mentioned basic user information and the like are used. If the user has already acquired a user account, the user can use the service by logging in after receiving predetermined authentication such as entering an ID and password. After this authentication, a predetermined user interface is provided via a website, an application, or the like, a video call service can be used, and proceeds to step S101 shown in FIG. 10.

First, as the processing of step S101, the input reception unit 131 of the control unit 130 of the server terminal 100 receives the viewpoint information from the interaction device 200A via the communication unit 110. As for the viewpoint information, for example, the information on the viewpoint position can be acquired by capturing the image of the user with the CCD camera 240 provided in the liquid crystal display unit 220 of the interaction device shown in FIG. 4. When the interaction device shown in FIG. 4 is used, it is preferable that the image of the interactive user is displayed at the central part of the liquid crystal display unit 220 (at the position where the camera 240 is provided). Here, in the interaction device 200A, after calculating the viewpoint position of the user based on the captured image, information related to the viewpoint position can be transmitted from the interaction device 200A to the server terminal 100, or after transmitting the image information to the server terminal 100, the viewpoint position can also be calculated by the analysis unit 132 of the control unit 130 of the server terminal 100 based on the received image.

Next, as the processing of step S102, the analysis unit 132 of the control unit 130 of the server terminal 100 analyzes the viewpoint information. Further, the analysis unit 132 links the viewpoint position of the user on the liquid crystal display unit (screen) as the viewpoint information to a specific user each time when the viewpoint information is acquired continuously or at predetermined time intervals, and is stored in the user data storage unit 121 and/or the analysis data storage unit 122. Further, the analysis unit 132 can track and store the user's viewpoint information in time series. Further, the analysis unit 132 counts the frequency that the user's viewpoint position is placed at a predetermined coordinate based on the viewpoint information, or can measure the time placed at a predetermined coordinate each time and calculate the cumulative total of the time. Further, as described above, the analysis unit 132 can also calculate the viewpoint position based on the image including the interactive user received from the interaction device 200A.

Next, as the processing of step S103, the emotion information generating unit 133 of the control unit 130 of the server terminal 100 generates emotion information based on the analyzed viewpoint information. For example, as shown in FIG. 7, the emotion information generating unit 133 may generate emotion information based on a predetermined protocol as to which range the user's viewpoint position is from the coordinates centered on the center of the liquid crystal display unit. For example, when the user's viewpoint position is at coordinates (0, 0), that is, in the center of the screen, the emotional information is generated indicating that the user is very positive (showing high interest) in communicating with the interactive user, whereas when the user's viewpoint is far from the center of the screen and is at the coordinates (−500, 500), the user can generate emotion information that is very negative (very low interest) in the communication. Alternatively, as described above, emotion information can be generated based on the input viewpoint information by machine learning from a learning model composed of the user's viewpoint information and emotion information.

Further, as shown in FIG. 8, information that visualizes changes in the transition of emotion information in time series can be generated, or as shown in FIG. 9, it is also possible to generate information that evaluates the user's feelings in the entire communication based on the frequency and/or the cumulative time of the coordinates at which the user's viewpoint is placed. As information that visualizes the generated emotion information, it is transmitted to the interaction device 200B and displayed on the display unit of the interaction device 200B, or in order to notify the user who uses the interaction device 200B of emotional information, it can be identified and displayed by an icon or the like based on the degree of emotion information (evaluation of the five steps above), or in order to sensuously transmit emotion information to the user, it is possible to generate and transmit a control signal for driving a notification unit such as a vibration motor of the interaction device 200B.

As described above, by generating emotion information based on the viewpoint position of the user, it becomes possible to share emotion information with each other in communication of remote users, and it is possible to improve the quality of communication.

Although embodiments according to the invention have been described above, these can be implemented in various other embodiments, and can be implemented with various omissions, replacements and changes. These embodiments and variations as well as those with omissions, substitutions and modifications are included in the technical scope of the claims and the equivalent scope thereof.

### DESCRIPTION OF REFERENCE NUMERALS

1: system, 100: server terminal, 110: communication unit, 120: storage unit, 130: control unit, 200: interaction device, NW: network

1. A device that supports a video interaction between a first user and a second user using an interaction device of a first user and an interaction device of a second user, who are located remotely apart from each other, the device comprising:
an input reception unit that receives viewpoint information of the first user on the interaction device of the first user;
an analysis unit that analyzes the viewpoint information; and
an emotion information generating unit that generates emotion information based on the analyzed viewpoint information.

2. The device of claim 1, further comprising:
an emotion information transmission unit that transmits the emotion information to the interaction device of the second user.

3. The device of claim 1, further comprising:
an emotion notification control unit that converts the emotion information into control information for controlling an emotion notification unit included in the interaction device of the second user.

4. The device of claim 1,
wherein the emotion information generating unit generates emotion information based on the viewpoint position on the interaction device included in the viewpoint information.

5. The device of claim 1,
wherein the emotion information generating unit generates emotion information based on the frequency or time of the viewpoint position on the interaction device included in the viewpoint information.
